(19) United States
(12) Patent Application Publication
(10) Pub. No.: US 2019/0225736 A1
(43) Pub. Date: Jul. 25, 2019

(54) REACTIVE POLYURETHANE PLASTICIZERS AND ADHESIVES MADE THEREFROM

(71) Applicant: DDP Specialty Electronic Materials US Inc., Midland, MI (US)

(72) Inventors: Daniel P. Sophiea, Lake Orion, MI (US); Caitlin E. Young, Birmingham, MI (US); Lirong Zhou, Rochester Hills, MI (US)

(21) Appl. No.: 16/375,494

(22) Filed: Apr. 4, 2019

Related U.S. Application Data
(63) Continuation of application No. 15/556,012, filed on Sep. 6, 2017.
(60) Provisional application No. 62/157,055, filed on May 5, 2015.

(51) Int. Cl. C08G 18/48; C09J 11/04; C09J 175/08; C08G 18/30; C08G 18/28; C08G 18/24; C08G 18/22; C08G 18/20; C08G 18/16; C08G 18/12; C08G 18/76

(52) U.S. Cl. CPC C08G 18/4845; C08K 3/04; C08G 18/4825; C08G 18/4804; C09J 175/08; C08G 18/307; C08G 18/283; C08G 18/244; C08G 18/227; C08G 18/2081; C08G 18/168; C08G 18/12; C08G 18/7671; C08G 18/7664; C08G 18/4829; C09J 11/04

(57) ABSTRACT

A reactive plasticizer is comprised of a reaction product of an isocyanate having two isocyanate groups and a linear polyether monol. The monol has a weight average molecular weight of about 500 to about 2000 grams/mole. The amount of isocyanate and linear polyether monol are such that the isocyanate groups are in molar excess of the amount of alcohol groups and the reaction product has an isocyanate content of 0.1% to 1% by weight of the reaction product, The reactive plasticizer is particularly useful for formulating one part moisture cured polyurethane adhesives comprised of the reactive filler, an isocyanate terminated prepolymer, filler and a catalyst.

### FIELD OF INVENTION

This invention relates to polyurethane plasticizers useful to make adhesives and in particular moisture cure polyurethane adhesives. These polyurethane plasticizers are useful for making high green strength, fast curing adhesives for bonding glass into vehicles or buildings.

### BACKGROUND OF INVENTION

Adhesive compositions are used to affix (bond) glass (windows) into buildings and vehicles, see Rizk, U.S. Pat. No. 4,780,520; Bhat, U.S. Pat. No. 5,976,305; Hsieh et al, U.S. Pat. No. 6,015,475 and Zhou, U.S. Pat. No. 6,709,539. In automobile factories, windows are installed using robots and computer controlled processing which facilitates the use of a variety of high performance adhesives. These adhesives have to be storage stable and readily applied under high shear, for example, to a windshield, while retaining a bead shape so that the windshield can be properly fitted to the automobile. This has been achieved by one part moisture curable polyurethane prepolymer based adhesives having fillers, prepolymers having sufficient molecular weight and, in particular, plasticizers, so that they are still pumpable and can be applied to the windshield without stringing, sagging while also quickly obtaining and retaining the sufficient strength and elasticity (i.e., low glass transition temperature T_{g}) required of an adhesive over the large range of environmental conditions encountered by an automobile.

The ability to apply high viscosity adhesives via pumps imparting high shear rates and maintain good bead geometry or shape and while holding heavy components in place without the use of mechanical fixtures such as tape or clips or clamps has required plasticizers. This rheological behavior has required the use of high boiling point (e.g., boiling point greater than about 85° C.) solvents, referred to as plasticizers. Unfortunately, plasticizers such as phthalate have caused health concerns such as possibly being a carcinogen and recently have come under further regulation. Likewise, plasticizers are known to migrate from adhesives over time and volatilize degrading the adhesive and fogging the vehicle's windows.

What is needed is a plasticizer and adhesive composition for bonding glass into a structure which may be formulated that exhibits multiple desirable characteristics including: low viscosity, low isocyanate content, high yield value and recovery after shear, low glass transition temperature (T_{g}) even after exposure to accelerated weathering and over time which can result in phase separation and volatilization of plasticizer. In addition, the composition should cure quickly after exposure to moisture with sufficient strength, elongation and Young's Modulus to have the windshield act as a structural element of the vehicle. It should also display quick buildup of strength and modulus to allow for fast safe drive away times when applied under a variety of conditions, while not displaying sag or string when applied even after undergoing high shear just prior to being applied.

Sag is the loss of the shape of the adhesive bead, often as the result of gravitational forces. If severe enough, this deformation can interfere in the proper installation and sealing of the window into the vehicle. Stringing of an adhesive is the formation of a long string of adhesive at the end of the bead of adhesive dispensed which can complicate application of the adhesive and cause imperfections in cured adhesive bead.

### SUMMARY OF INVENTION

A first aspect of the invention is a reactive plasticizer useful in moisture cure polyurethane adhesives comprising, an isocyanate terminated linear polyether comprised of ethylene oxide and propylene oxide groups wherein, one end of said isocyanate terminated linear polyether is terminated with an isocyanate and the other end is a group that is unreactive with isocyanates and groups having an active hydrogen that reacts with isocyanates, a weight average molecular weight of about 500 to 3000 grams/mole, and an ethylene oxide/propylene oxide group ratio by number of said ethylene oxide and propylene oxide groups of greater than 0.2 to 1.

A second aspect of the invention is a reactive plasticizer comprising the reaction product of an isocyanate having two isocyanate groups and a linear polyether monol having one alcohol group, said monol having a weight average molecular weight of about 500 to about 2000 grams/mole, wherein the amount of isocyanate and linear polyether monol are such that the isocyanate groups are in molar excess of the amount of alcohol groups and the reaction product has an isocyanate content of 0.1% to 1% by weight of the reaction product.

A third aspect of the invention is an adhesive composition comprised of: the reactive plasticizer of the first or second aspect of the invention; an isocyanate functional polyether prepolymer having an isocyanate content of 0.6% to 5% by weight of the prepolymer and average isocyanate functionality of about 1.8 to 3; a filler; and an isocyanate catalyst.

A variety of substrates may be bonded together using the adhesive composition for instance, plastics, glass, wood, ceramics, metal, coated substrates, such as plastics with an abrasion resistant coating disposed thereon, and the like. The compositions of the invention may be used to bond similar and dissimilar substrates together. The compositions are especially useful for bonding glass or a plastic with an abrasion resistant coating disposed thereon to other substrates such as vehicles and buildings. The compositions of the invention are also useful in bonding parts of modular components together, such as vehicle modular components. The glass or plastic with an abrasion resistant coating disposed thereon can be bonded to coated and uncoated portions of vehicles.

Surprisingly, the adhesive is pumpable at temperatures between about 20° C. and about 80° C., while exhibiting low sag and string even though the composition has little or no traditional plasticizer. Preferably, the composition exhibits a sag of less than about 5 mm. This allows the adhesives prepared from the composition of the invention to be applied at a wide range of ambient temperatures. Heated application machinery is not necessary for the application of the adhesive, but surprisingly, the composition of this invention, may also be applied if warmed over ambient temperatures (i.e., greater than about 23° C. to about 90° C.).

Furthermore, the adhesive demonstrates rapid strength development which facilitates rapid drive away times of preferably one hour, and more preferably 30 minutes, after application of the adhesive at temperatures of from about 0° F. (−18° C.) to about 115° F. (46° C.). In particular, windshields installed under such conditions meet United States Federal Motor Vehicle Safety Standard (FMVSS) 212. In some preferred embodiments, the compositions of the invention are nonconductive and demonstrate a dielectric constant of about 15 or less. The compositions of the invention typically demonstrate a modulus after application for two weeks of about 1 MPa or greater, more preferably about 2 MPa or greater and preferably about 4 MPa or less according to ASTM D4065 measured at 25° C. This modulus is desirable because it allows for a compliant enough adhesive to absorb the vibrations and shock experienced by a windshield in an automobile and still has the strength to adhere the windshield in the automobile.

### DETAILED DESCRIPTION OF INVENTION

### Reactive Plasticizer

A reactive plasticizer that sufficiently plasticizes a moisture cured one part polyurethane adhesive while still achieving good mechanical properties such as elongation and tensile strength, application properties such as little or no sag or stringing and ease of pumping, and storage stability while eliminating or minimizing volatilization associated with traditional plasticizers has been discovered. The reactive plasticizer may be added to any number of moisture cured adhesive compositions comprised of isocyanate terminated prepolymers such as those known in the art.

The reactive plasticizer is formed by reacting a diisocyanate with a linear polyether having one terminal hydroxyl (alcohol) group and no other groups that are reactive with an isocyanate in a stoichiometric excess of the diisocyanate. It is understood that there may be small amounts of polyethers or isocyanates that have differing functionality (i.e., 1 for the linear polyether and 2 for the diisocyanate) so long as the average functionality is within at least 10%, preferably 5% and more preferably within 2% of the aforementioned functionality.

The reactive plasticizer is formed by reacting a linear polyether monol having a weight average molecular weight (M_{w}) of about 500 to 2000 grams/mole with a diisocyanate. The polyether monol is comprised of alkylene oxide units such as those known in the art. Exemplary alkylene oxide units, include ethylene oxide, propylene oxide, butylene oxide or a mixture thereof. In an embodiment of the reactive plasticizer particularly useful for use in the one part moisture cure polyurethane the polyether monol contains at least some amount of ethylene oxide units and preferably at least about 0.2 of the alkylene oxide units by mole are ethylene oxide units to all of the backbone being ethylene oxide units. Desirably, the polyether monol has ethylene oxide and propylene oxide units in a ratio of ethylene oxide/propylene oxide of greater than 0.2 to 1. Preferably, said ratio is from 0.3 to 0.8 and more preferably from 0.4 to 0.6. The alkylene oxide units may be random or blocks when more than one type of unit is present. Such monols are available under the trade name UCON from The Dow Chemical Company, Midland, Mich.

One end of the monol is the alcohol group and the other end of the monol is a group that is unreactive with an isocyanate or alcohol group. Exemplary groups terminating the other end of the monol are ethers and esters.

The diisocyanate may be any of those known in the art including, for example, any aliphatic, cycloaliphatic, araliphatic, heterocyclic or aromatic polyisocyanate, or mixtures thereof. It is understood that the functionality of the diisocyanate is 2, but that the functionality of the diisocyanate may vary slightly due, for example, its preparation or oligomerization, but generally is within 1.9 to 2.1. Exemplary diisocyanates include ethylene diisocyanate; isophorone diisocyanate; bis(4-isocyanate cyclohexyl) methane; trimethyl hexamethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3-diisocyanate; 1,4-diisocyanate; 1-isocyanato3,3,5-trimethyl5-isocyanato methyl cyclohexane; 2,4-hexahydrotolylene diisocyanate; 2,6-hexahydrotolylene diisocyanate; hexahydro1,3-phenylene diisocyanate; hexahydro1,4-phenylene diisocyanate; perhydro-2,5′-diphenyl methane diisocyanate; 4,4′-diphenyl methane diisocyanate; 2,4′-diphenyl methane diisocyanate; 2,2′-diphenyl methane diisocyanate; 1,3-phenylene diisocyanate; 1,4-phenylene diisocyanate; 2,4′-tolylene diisocyanate; 2,6-tolylene diisocyanate and diphenylmethane2,4′-diisocyanate; diphenylmethane 4,4′-diisocyanate, naphthylene-1,5-diisocyanate; tetramethylxylene diisocyanate or mixture thereof. Preferably, the diisocyanate is 4,4′-diphenyl methane diisocyanate; 2,4′-diphenyl methane diisocyanate; 2,2′-diphenyl methane diisocyanate; or mixture thereof. More preferably the diisocyanate is 4,4′-diphenyl methane diisocyanate.

When reacting the monol with the diisocyanate, a slight excess of diisocyanate is used to ensure that there are no residual alcohol groups. Generally the excess amount of diisocyanate that is used results in an amount of isocyanate in the reactive plasticizer that is from about 0.01% to 1% by the total weight of the reactive plasticizer. Generally, the molar ratio of diisocyanate/monol is about 1.001 to 1.05.

In an embodiment, the reactive plasticizer is an isocyanate terminated linear polyether comprised of ethylene oxide and propylene oxide groups wherein, one end of said isocyanate terminated linear polyether is terminated with an isocyanate and the other end is a group that is unreactive with isocyanates and groups having an active hydrogen that reacts with isocyanates, a weight average molecular weight of about 500 to 3000 grams/mole, preferably 500 to 2500 or 2000 g/mole, and an ethylene oxide/propylene oxide group ratio by number of said ethylene oxide and propylene oxide groups of greater than 0.2 to 1. Preferably, the backbone of this embodiment consists of only propylene oxide and ethylene oxide groups. Preferably, the ethylene oxide/propylene oxide group ratio is 0.3 or 0.4 to 0.6 or 0.8. Preferably, the other end group is an ether.

The reactive plasticizer may be prepared by any suitable method such as described below to make the isocyanate prepolymer described below.

The viscosity of the reactive plasticizer generally is from about 500 to about 3000 centipoise as measured by using a Brookfield Engineering D-VIII™ Viscometer employing a number 7 spindle at 20 rpm after 60 sec at 23±2° C. The initial viscosity was measured ˜24 hours at ambient temperature (23° C.÷2° C.) after preparation. The heat age viscosity is determined after aging the just mentioned 24 hours and then aging at 65° C. for 3 days.

### Moisture Cure One Part Polyurethane Adhesive

The moisture cure one part polyurethane adhesive is comprised of the reactive plasticizer, an isocyanate terminated prepolymer, filler and an isocyanate catalyst. The reactive plasticizer typically is present in an amount of about 10% to 40% of the total weight of the adhesive. Desirably, the amount of the reactive plasticizer is present in an amount of at least 15% or 20% to at most about 35% by weight of the adhesive.

The isocyanate terminated prepolymer is present in sufficient quantity to provide adhesive character to the adhesive. Such prepolymers have an average isocyanate functionality sufficient to allow the preparation of a crosslinked polyurethane upon cure and not so high that the polymers are unstable. “Stability” in this context means that the prepolymer or adhesive prepared from the prepolymer has a shelf life of at least four months at ambient temperatures, in that it does not demonstrate an increase in viscosity during such period which prevents its application or use. For example, the viscosity should not rise too greatly to make it impractical to pump the adhesive composition. Preferably, the prepolymer or adhesive prepared therefrom does not undergo an increase in viscosity of more than about 50 percent during the stated period.

The prepolymer preferably has a free isocyanate content which facilitates acceptable strength in adhesives prepared from the prepolymers after 60 minutes and stability of the prepolymer. Preferably, the free isocyanate content is about 0.6 percent by weight or greater based on the weight of the prepolymer and more preferably about 0.8 percent by weight or greater, and preferably about 5.0 percent by weight or less, more preferably about 3.5 or less, even more preferably about 3.0 percent by weight or less, and even more preferably about 2.6 percent by weight or less. Above about 5.0 percent by weight, the adhesives prepared from the prepolymer may demonstrate lap shear strengths after 60 minutes that may be too low for the intended use. Below about 0.8 percent by weight, the prepolymer viscosity may be too high to handle and the working time may be too short.

The prepolymer preferably exhibits a viscosity, which facilitates formulation of a pumpable adhesive which has good green strength. Preferably, the viscosity of the prepolymer is about 100,000 centipoise (100 Pa s) or less and more preferably about 50,000 centipoise (50 Pa s) or less, and most preferably about 30,000 centipoise (30 Pa s) or less and about 1,000 centipoise (1 Pa s) or greater. The viscosity of the adhesive can be adjusted with fillers, although the fillers generally do not improve the green strength of the final adhesive. Below about 1,000 centipoise (1 Pa s), the adhesive prepared from the prepolymer may exhibit poor green strength. Above about 100,000 centipoise (100 Pa s) the prepolymer may be unstable and hard to dispense. Prepolymer viscosity is measured using Brookfield viscometer at 20 rpm using a #6 spindle at 23° C.±2° C.

When making the isocyanate terminated prepolymer of this invention, the polyisocyanate generally has an isocyanate functionality of about 2 to about 3.5. It is understood that when referring to the isocyanate functionality, it is referring to the theoretical functionality, which can generally be calculated from the stoichiometry of the ingredients used, but the actual functionality may he different, for example, due to imperfections in raw materials, incomplete conversion of the reactants and formation of bi-products.

Any of polyisocyanates that realizes the aforementioned functionality may be used. For example, the polyisocyanates may be any aliphatic, cycloaliphatic, araliphatic, heterocyclic or aromatic polyisocyanate, or mixtures thereof. Illustratively, the polyisocyanates may include those disclosed by Wu, U.S. Pat. No. 6,512,033 at column 3, line 3 to line 49. More preferred isocyanates are aromatic isocyanates, alicyclic isocyanates and derivatives thereof. Preferably, the aromatic isocyanates have the isocyanate groups bonded directly to aromatic rings. Preferably, the polyisocyanate is comprised of an oligomer of an aromatic or cycloaliphatic polyisocyanate such as diphenyl-methane-4,4′-diisocyanate (MDI), isophorone diisocyanate, tetramethylxylene diisocyanate or mixture thereof. Exemplary polyisocyanates include ISONATE 125 M, ISONATE 50 OP, PAPI 94 or PAPI 27 polyisocyanates available from The Dow Chemical Company, Midland, Mich.

Desirably, the equivalent weight of the polyisocyanate is at least about 80, more preferably at least about 110, and is most preferably at least about 120, and is preferably no greater than about 600, more preferably no greater than about 500, and most preferably no greater than about 300.

The amount of polyisocyanate used to prepare the prepolymer is that amount that gives the desired properties, that is, the appropriate free isocyanate content and viscosities as discussed herein. Preferably, the polyisocyanates are used to prepare in the prepolymer in an amount of about 1.1 equivalents of isocyanate (NCO) per equivalent of active hydrogen or greater, more preferably about 1.2 equivalents of isocyanate or greater and most preferably about 1.5 equivalents of isocyanate or greater. Preferably, the polyisocyanates used to prepare the prepolymer are used in an amount of about 2.2 equivalents of isocyanate or less, more preferably 2.0 equivalents of isocyanate or less and most preferably about 1.9 equivalents of isocyanate or less.

The isocyanate terminated prepolymers are made from active hydrogen compounds such as described by U.S. Pat. No. 5,922,809 at column 4, line 38 to column 5, line 50 and Wu, U.S. Pat. No. 6,512,033 at col. 3, line 57to col. 4, line 64. Preferably the active hydrogen compounds are polyols. Exemplary polyols include polyether polyols, poly(alkylene carbonate)polyols, hydroxyl containing polythioethers and mixtures thereof, which are also described in the above cited references. The polyol (diols and triols) are preferably polyether polyols containing one or more alkylene oxide units in the backbone of the polyol. Preferred alkylene oxide units are ethylene oxide, propylene oxide, butylene oxide and mixtures thereof. Preferably, the polyol contains propylene oxide units, ethylene oxide units or a mixture thereof. The alkylene oxides can contain straight or branched chain alkylene units.

In an embodiment containing polyether polyols containing ethylene oxide (EO) and propylene oxide (PO) units, the ethylene oxide content in the prepolymer is typically about 20% to 80 percent by weight of the polyol. Desirably the EO content is 5% or 10% to 50%, 40% or 30 percent by weight of the polyol. When making the prepolymer with a polyether polyol a small amount of other polyols may be used to form the prepolymer such as a polyester polyol such as those known in the art. Typically, such other polyols may be present in an amount of about up to 5% by weight of the polyol used to make said prepolymer.

When the polyol is a polyether polyol, it may be random or a block polymer of differing polyether units. Desirably, the polyol is ethylene oxide-capped such as occurs when reacting glycerin with propylene oxide, followed by reacting the product with ethylene oxide (i.e., EO capped polyether polyol).

In an embodiment, the polyol is comprised of a diol and triol. The diol has a weight average molecular weight (M_{w}) of 200 to 8000 grams. Preferably, the diol has an M_{w} of 500 to 4,000, or 1,000 to 3,000 or 1,500 to 2,500 grams/mole. The triol has an M_{w} of 100 to 10,000 grams/mole. Preferably, the triol has an M_{w} of 700 to 6,000 or 1,500 to 4,500 grams/mole. Desirably, the triol has an EO content is from about 5% to 60% by weight of the triol and preferably is from 10% or 15% to 50% or 30% of the triol by weight. Desirably, the diol has an EO content that is less than about 40%, 30%, 20%, 10%, 5% or even 0% by weight of the diol.

Exemplary polyols (diols and triols) include polyols available from The Dow Chemical Company, Midland, Mich. such as VORANOL™ 220-028 a 4000 molecular weight polyether diol, VORANOL™ 220-094, a propylene glycol initiated 1200 molecular weight homopolymer diol, VORANOL™ 220-110N a propylene glycol initiated 1000 molecular weight homopolymer polyether diol, VORANOL™ 220-260 a 425 molecular weight homopolymer polyether diol, VORANOL™ 220-530 an amine initiated polyether polyol, VORANOL™ 221-050 a 2200 molecular weight diol, VORANOL™ 222-029 a 4000 molecular weight polyether diol based on propylene oxide with ethylene oxide capping, VORANOL™ 222-056 a 2000 molecular weight polyether diol based on propylene oxide with ethylene oxide capping, VORANOL™ 2070 is a glycerine initiated, 700 molecular weight, homopolymer triol polyol, VORANOL™ 225 is a 250 molecular weight glycerine-initiated polyether triol, VORANOL™ 230-056 a glycerine-initiated homopolymer polyether triol with a nominal 3000 molecular weight, VORANOL™ 230-112 is a polyether homopolymer triol with a nominal molecular weight of 1500, VORANOL™ 230-660 is a 250 molecular weight polyether triol, VORANOL™ 232-034 is an EO capped polyether triol with nominal molecular weight of 4800, VORANOL™ 232-035 is a nominal 5000 molecular weight, EO capped polyether triol. The aforementioned molecular weights are M_{w}.

The isocyanate prepolymer typically has an M_{w} between 10,000 to about 200,000 g/mole. The “molecular weight average” used herein is the weight average molecular weight (M_{w}) as defined on page199 of Textbook of Polymer Science 3^{rd} Edition, Billmeyer, F. W. Jr., John Wiley and Sons, NY, N.Y., 1984. Desirably, the M_{w} average is at least in ascending desirability: 20,000, 30,000, 40,000, 50,000 and 55,000 to at most about 150,000 or even at most about 100,000.

The isocyanate terminated prepolymer may be prepared by any suitable method, such as bulk polymerization and solution polymerization. Exemplary processes useful to make the prepolymers are disclosed in U.S. Pat. No. 5,922,809 at column 9, lines 4 to 51. The polyurethane prepolymers are present in the adhesive composition in an amount sufficient such that when the resulting adhesive cures, substrates are bound together. The reaction to prepare the prepolymer is carried out under anhydrous conditions, preferably under an inert atmosphere such as a nitrogen blanket to prevent crosslinking of the isocyanate groups by atmospheric moisture. The reaction is preferably carried out at a temperature between about 0° C. and about 150° C., more preferably between about 25° C. and about 90° C., until the residual isocyanate content determined by titration of a sample is very close to the desired value. “Isocyanate content” means the weight percentage of isocyanate moieties to the total weight of the prepolymer.

The reactions to prepare the prepolymer may be carried out in the presence of urethane catalysts. Examples of such include the stannous salts of carboxylic acids, such as stannous octoate, stannous oleate, stannous acetate, and stannous laurate. Also, dialkyltin dicarboxylates such as dibutyltin dilaurate, dibutyltin diacetate, dimethyl tin dilaurate and dimethyltin diacetate are known in the art as urethane catalysts, as are tertiary amines such as triethyldiamine and tin mercaptides. Preferably, the reaction to prepare the prepolymer is catalyzed by stannous octoate. The amount of catalyst employed is generally between about 0.005 and about 5 parts by weight of the mixture catalyzed, depending on the nature of the isocyanate.

When making an adhesive composition the reactive plasticizer, prepolymer, filler and catalyst are mixed together after each has been formed.

The prepolymer is typically present in an amount of about 20 parts by weight of the adhesive or greater, more preferably about 30 parts by weight or greater and most preferably about 35 parts by weight or greater. Preferably, the prepolymers are present in an amount of about 60 parts by weight of the adhesive composition or less, more preferably about 50 parts by weight or less and even more preferably about 45 parts by weight or less.

The filler is generally necessary to achieve the rheological properties such as pumpability, sag and string useful when the adhesive composition is used to install windows in vehicles and buildings. The filler may be any useful such as those known in the art and include, for example, carbon black, calcium carbonate, coal or fly ash, clays and other inorganic particulates. Any combination or mixture of fillers may be used.

Typically, the total amount of the filler is about 10% to 40% by weight of the adhesive. It is preferred that at least a portion of the filler is carbon black. The carbon blacks depending on their structure and the molecular weight of the prepolymers may range over a wide range of structures as given by oil absorption number (ASTM D-2414-09). For example, the carbon black typically should be an oil absorption number (OAN) of about 80 to 200 ccs per 100 grams. Preferably, the oil absorption of the carbon is at least about 90, more preferably at least about 100, and most preferably at least about 110 to preferably at most about 180, more preferably at most about 165 and most preferably at most about 150 ccs/100 grams.

In addition the carbon black desirably has an iodine number that is at least 80. The iodine number is related to the surface area of the carbon black, but also to the presence of volatile species such as unsaturated oils and, sulfur containing compounds. The iodine number is determined using ASTM D1510-11.

The amount of carbon black suitable may be determined for a given carbon black and by routine experimentation. Typically, the amount of carbon black is at least in ascending desirability, 5%, 10%, 15%, 18% or 23% to at most, in ascending desirability, 32%, 30% or 28% by weight of the adhesive composition.

The carbon black used in this invention may be a standard carbon black which is not specially treated to render it nonconductive. Standard carbon black is carbon black which is not specifically surface treated or oxidized. Alternatively, one or more nonconductive carbon blacks may be used exclusively or in conjunction with the standard carbon black. Suitable standard carbon blacks include Monarch 5700, Monarch 580, Elftex 5100 or Elftex 7100 carbon blacks available from Cabot Corporation, Arosperse 11 carbon black available from Colombian Chemicals Company, Centerville, LN, and PRINTEX™ 30 carbon black available from Evonik Industries, Mobile, Ala. Suitable non-conductive carbon blacks include RAVEN™ 1040 and RAVEN™ 1060 carbon black available from Colombian Chemicals Co.

The adhesive also contains a catalyst which catalyzes the reaction of isocyanate moieties with water or an active hydrogen containing compound and include those already described above in making the prepolymer. The catalyst may be any catalyst known to the skilled artisan for the reaction of isocyanate moieties with water or active hydrogen containing compounds. Preferred catalysts include organotin compounds, metal alkanoates, and tertiary amines. Mixtures of classes of catalysts may be used. A mixture of a tertiary amine and a metal salt is desirable. Tertiary amines, such as dimorpholino diethyl ether (DMDEE), and a metal alkanoate, such as bismuth octoate are a preferred catalyst mixture. Included in the useful catalysts are organotin compounds such as alkyl tin oxides, stannous alkanoates, dialkyl tin carboxylates and tin mercaptides. Stannous alkanoates include stannous octoate. Alkyl tin oxides include dialkyl tin oxides, such as dibutyl tin oxide and its derivatives. The organotin catalyst is preferably a dialkyltin dicarboxylate or a dialkyltin dimercaptide. Dialkyl tin dicarboxylates with lower total carbon atoms are preferred as they are more active catalysts in the compositions of the invention. The preferred dialkyl dicarboxylates include 1,1-dimethyltin dilaurate, 1,1-dibutyltin diacetate and 1,1-dimethyl dimaleate. Preferred metal alkanoates include bismuth octoate or bismuth neodecanoate. If the organo tin or metal alkanoate catalyst is present, it typically is present in an amount of about 60 parts per million or greater based on the weight of the adhesive, more preferably 120 parts by million or greater. The total amount of catalysts in the adhesive composition is generally at most about 5%, 2% or 1% to at least about 0.01%, 0.1% or 0.4% by weight of the adhesive composition.

Useful tertiary amine catalysts include dimorpholinodialkyl ether, a di((dialkylmorpholino)alkyl) ether, bis-(2-dimethylaminoethyl)ether, triethylene diamine, pentamethyldiethylene triamine, N,N-dimethylcyclohexylamine, N,N-dimethyl piperazine 4-methoxyethyl morpholine, N-methylmorpholine, N-ethyl morpholine and mixtures thereof. A preferred dimorpholinodialkyl ether is dimorpholinodiethyl ether. A preferred di((dialkylmorpholino)alkyl) ether is (di-(2-(3,5-dimethyl-morpholino)ethyl)-ether). Tertiary amines are preferably employed in an amount, based on the weight of the adhesive of about 0.01 percent by weight or greater, more preferably about 0.05 percent by weight or greater, even more preferably about 0.1 percent by weight or greater and most preferably about 0.2 percent by weight or greater and about 2.0 percent by weight or less, more preferably about 1.75 percent by weight or less, even more preferably about 1.0 percent by weight or less and most preferably about 0.4 percent by weight or less.

Surprisingly the reactive plasticizer allows for a one part moisture cure polyurethane adhesive to be made without any traditional plasticizers that leach and volatilize out of the cured adhesive, while still achieving the desired attributes (e.g., sag, string, fast cure, modulus, T_{g}, and adhesion). Even though, some traditional plasticizer may be used, but they are neither necessary nor preferred.

If used, the traditional plasticizer should be free of water, inert to isocyanate groups and compatible with the prepolymer and reactive plasticizer. Such material may be added to the reaction mixtures for preparing the prepolymer, or to the mixture for preparing the final adhesive composition, but is preferably added to the reaction mixtures for preparing the prepolymer, so that such mixtures may be more easily mixed and handled. Suitable plasticizers are well known in the art and include straight and branched alkyl phthalates, such as diisononyl phthalate, dioctyl phthalate and dibutyl phthalate, a partially hydrogenated terpene commercially available as “HB-40” and castor oil.

Other traditional plasticizers include one or more of alkyl esters of sulfonic acid, alkyl alkylethers diesters, polyester resins, polyglycol diesters, polymeric polyesters, tricarboxylic esters, dialkylether diesters, dialkylether aromatic esters, aromatic phosphate esters, aromatic sulfonamides and alkyl esters of natural oils such as soy, castor, sunflower, linseed and corn or alkyl esters of their individual fatty acids such as palmitic, oleic and linoleic. More preferred high polar plasticizers include aromatic sulfonamides, aromatic phosphate esters, dialkyl ether aromatic esters and alkyl esters of sulfonic acid. Most preferred plasticizers include alkyl esters of sulfonic acid and toluene-sulfamide. Alkyl esters of sulfonic acid include alkylsulphonic phenyl ester available from Lanxess under the trademark MESAMOLL. Aromatic phosphate esters include PHOSFLEX™ 31 L isopropylated triphenyl phosphate ester, DISFLAMOLL™ DPO diphenyl-2-ethyl hexyl phosphate, and DISFLAMOL™ TKP tricresyl phosphate. Dialkylether aromatic esters include BENZOFLEX™ 2-45 diethylene glycol dibenzoate. Aromatic sulfonamides include KETJENFLEX™ 8 o and p, N-ethyl toluenesulfonamide. Vegetable based plasticizers may also be used, including alkyl esters of soy such as available under the tradename SOYGOLD 1000™, COLUMBUS 970 or Gold 4EG or canola oil, Columbus 973.

The adhesive may further comprise a free polyfunctional isocyanate, for example, which may improve the modulus of the cured adhesive composition or adhesion of the adhesion composition to particular substrates such as painted substrates. “Polyfunctional” as used in the context of the isocyanates refers to isocyanates having a functionality of 2 or greater. The polyisocyanates can be any monomeric, oligomeric or polymeric isocyanate having a nominal functionality of about 2.5 or greater. More preferably, the polyfunctional isocyanate has a nominal functionality of about 3 or greater. Preferably, the polyfunctional isocyanate has a nominal functionality of about 5 or less, even more preferably about 4.5 or less and most preferably about 3.5 or less. The polyfunctional isocyanate can be any isocyanate which is reactive with the isocyanate polyisocyanate prepolymers used in the composition and which improves the modulus of the cured composition. The polyisocyanates can be monomeric; trimeric isocyanurates or biurets of monomeric isocyanates; oligomeric or polymeric, the reaction product of several units of one or more monomeric isocyanates. Examples of preferred polyfunctional isocyanates include trimers of hexamethylene diisocyanate, such as those available from Bayer AG under the trademark and designation DESMODUR N3300, and polymeric isocyanates such as polymeric MDI (methylene diphenyl diisocyanates) such as those marketed by The Dow Chemical Company under the trademark of ISONATE or PAPI, including PAPI 20, PAPI 580 N, PAPI 94 or PAPI 27 polymeric isocyanates.

The polyfunctional isocyanates, when present are typically present in an amount sufficient to impact the modulus of the cured compositions of the invention or improve the adhesion to certain substrates described above. The polyfunctional isocyanate, when present, is preferably present in an amount of about 0.5 parts by weight or greater based on the weight of the adhesive composition, more preferably about 1.0 parts by weight or greater and most preferably about 2 parts by weight or greater. The polyfunctional isocyanate is preferably present in an amount of about 8 parts by weight or less, based on the weight of the adhesive composition, more preferably about 5 parts by weight or less and most preferably about 4 parts by weight or less.

The adhesive may further comprise stabilizers, which function to protect the adhesive from moisture, thereby inhibiting advancement and preventing premature crosslinking of the isocyanates in the adhesive composition. Stabilizers known to the skilled artisan for moisture curing adhesives may be used. Included among such stabilizers are diethylmalonate, alkylphenol alkylates, paratoluene sulfonic isocyanates, benzoyl chloride and orthoalkyl formates. However, it has been surprisingly discovered that the adhesive containing the reactive plasticizer, generally should have lower amounts than adhesives made solely using a nonreactive plasticizer. For example, it is generally preferred that at most 0.2 part by weight of such stabilizers are used and more preferably at most about 0.02 parts or even no stabilizers such as diethylmalonate is present. If too much stabilizer is present, the adhesive may take too long to cure or may not cure adequately.

The adhesive may further comprise a hydrophilic material that functions to draw atmospheric moisture into the composition. This material enhances the cure speed of the formulation by drawing atmospheric moisture to the composition. Preferably, the hydrophilic material is a liquid. Among preferred hydroscopic materials are pyrolidinones such as 1 methyl-2-pyrolidinone, available from under the trademark M-PYROL. The hydrophilic material is preferably present in an amount of about 0.1 parts by weight or greater and more preferably about 0.3 parts by weight or greater and preferably about 1.0 parts by weight or less and most preferably about 0.6 parts by weight or less. Optionally, the adhesive composition may further comprise a thixotrope. Such thixotropes are well known to those skilled in the art and include alumina, limestone, talc, zinc oxides, sulfur oxides, calcium carbonate, perlite, slate flour, salt (NaCl), cyclodextrin, amorphous solid polyester and the like. The thixotrope may be added to the adhesive of a composition in a sufficient amount to give the desired rheological properties. Preferably, the thixotrope is present in an amount of about 0.01 parts by weight or greater based on the weight of the adhesive composition, preferably about 2 part by weight or greater.

Other components commonly used in such adhesives may he used. Such materials include those known in the art and may include ultraviolet stabilizers and antioxidants and the like.

As used herein, all parts by weight relative to the components of the adhesive are based on 100 total parts by weight of the adhesive.

The adhesive may be formulated by blending the components together using means well known in the art. Generally, the components are blended in a suitable mixer. Such blending is preferably conducted in an inert atmosphere in the absence of oxygen and atmospheric moisture to prevent premature reaction. As appropriate, depending on the components to be blended, the adhesive composition may be blended at an elevated temperature, for example, to melt components that may be solid at room temperature. For example, the temperatures utilized are typically room temperature or from about 40° C. to less than about 90° C. and more preferably about 50° C. to about 70° C. It may be advantageous to add any plasticizers, if desired, to the reaction mixture for preparing the isocyanate terminated prepolymer so that such mixture may be easily mixed and handled. Alternatively, the plasticizers can be added during blending of all the components. Once the adhesive is formulated, it is packaged in a suitable container such that it is protected from atmospheric moisture and oxygen. Contact with atmospheric moisture and oxygen could result in premature crosslinking of the polyurethane prepolymer-containing isocyanate groups.

The adhesive may be used to bond a variety of substrates together as described before. The composition can be used to bond porous and nonporous substrates together. The adhesive composition is applied to a substrate and the adhesive on the first substrate is thereafter contacted with a second substrate. In preferred embodiments, the surfaces to which the adhesive is applied are cleaned and primed prior to application, see for example, U.S. Pat. Nos. 4,525,511; 3,707,521 and 3,779,794; relevant parts of all are incorporated herein by reference. Generally, the adhesives of the invention are applied at ambient temperature in the presence of atmospheric moisture. Exposure to atmospheric moisture is sufficient to result in curing of the adhesive. Curing can be accelerated by the addition of additional water or by applying heat to the curing adhesive by means of convection heat, microwave heating and the like. Preferably, the adhesive is formulated to provide a working time of about 6 minutes or greater, and more preferably about 12 minutes or greater. Preferably, the working time is about 60 minutes or less and more preferably about 30 minutes or less.

The adhesive is preferably used to bond glass or plastic coated with an abrasion resistant coating, to other substrates such as bare or painted metals or plastics. In a preferred embodiment, the first substrate is a glass, or plastic coated with an abrasion resistant coating, and the second substrate is a window frame. In another preferred embodiment, the first substrate is a glass, or plastic coated with an abrasion resistant coating, and the second substrate is a window frame of an automobile. Preferably, the glass window is cleaned and has a glass primer applied to the area to which the adhesive is to be bonded. The plastic coated with an abrasion resistant coating can be any plastic which is clear, such as polycarbonate, acrylics, hydrogenated polystyrene or hydrogenated styrene conjugated diene block copolymers having greater than 50 percent styrene content. The coating can comprise any coating which is abrasion resistant such as a polysiloxane coating. Preferably, the coating has an ultraviolet pigmented light blocking additive. Preferably, the glass or plastic window has an opaque coating disposed in the region to be contacted with the adhesive to block UV light from reaching the adhesive.

In a preferred embodiment, the adhesive is used to replace windows in structures or vehicles and most preferably in vehicles. The first step is removal of the previous window. This can be achieved by cutting the bead of the adhesive holding the old window in place and then removing the old window. Thereafter the new window is cleaned and primed. The old adhesive that is located on the window flange can be removed, although it is not necessary and in most cases it is left in place. The window flange is preferably primed with a paint primer. The adhesive is applied in a bead to the periphery of the window located such that it will contact the window flange when placed in the vehicle. The window with the adhesive located thereon is then placed into the flange with the adhesive located between the window and the flange. The adhesive bead is a continuous bead that functions to seal the junction between the window and the window flange. A continuous bead of adhesive is a bead that is located such that the bead connects at each end to form a continuous seal between the window and the flange when contacted. Thereafter the adhesive is allowed to cure.

In another embodiment, the compositions of the invention can be used to bond modular components together. Examples of modular components include vehicle modules, such as door, window or body.

### Testing and Analytical Procedures

The press flow viscosity was determined as per SAE-J1524 and as follows. The uncured adhesive compositions were measured at 23° C. The press flow viscosity was measured by passing the uncured adhesive through a nozzle having a diameter of 4 mm and bore length of 5 cm under an applied air pressure of 4 bar and the amount of time in seconds for 20 grams of material to flow though the nozzle is recorded in seconds.

The initial viscosity of the reactive plasticizer was measured ˜24 hours after being made and being kept at ambient temperature (23° C.±2° C.) for that 24 hours. The heat age viscosity was determined after further aging for 3 days at 65° C.

The viscosity of the of the reactive plasticizer was measured using a Brookfield Engineering D-VIII™ Viscometer employing a number 7 spindle at 20 rpm after 60 sec at 23±2° C. The viscosity in the screening test was determined in the same way. Screening test samples were made by mixing 15% dry carbon black with 85% reactive plasticizer in a Hauschild Speed Mixer, model DAC 400 FV2 from Flack Tek, Inc. operating at 2000 rpm for 2 minutes, sealed in containers under dry nitrogen for at least 16 hours before the shear modulus and viscosity was determined.

The Young's modulus, tensile strength and elongation of the cured adhesive (23° C.±2° C. at 50%±5% Relative Humidity) compositions were determined as per ASTM D638.

The tear strength of the cured adhesive compositions was determined as per ASTM D624 in N/mm.

The weight % of NCO in the prepolymers was determined by titration as per ASTM D2572-97 (2010).

The Shear Storage Modulus, G′ was measured using TA Instruments AR2000™n Rheometer. Dynamic Stress Sweep Test: 1-1500 Pa Stress Sweep, 1 Hz Frequency, Log 10 Data Collection, 25 mm Parallel Plate, 25° C. Test Temperature, 1 minute equibrilation before starting test. Modulus G′ value in Pa was recorded at 100 Pa Stress.

The Yield Stress in Pa was measured using Brookfield R/S SST™Viscometer at 0.5 RPM Rotation Rate, 60 s, 60 Data points collected in Linear Mode, Plot Gamma (Strain).

### Illustrative Embodiments of the Invention

The following examples are provided to illustrate the invention, but are not intended to limit the scope thereof. All parts and percentages are by weight unless otherwise indicated. Table 1 shows the materials used.

### Reactive Plasticizer Preparation

3000 gm reactive plasticizer batches were prepared individually in a 4000 ml Pyrex glass reactor fitted with 4-port ground glass lid to accommodate an air driven stirring blade, digital thermometer, dry nitrogen gas inlet and nitrogen outlet. The reaction temperature was controlled using a heating jacket connected to an automatic electronic control module.

The reactive plasticizers shown in Tables 2-4 were made introducing the isocyanate material (i.e., ISONATE 125 M, ISONATE 50 OP or PAPI 94) to the covered reactor through the nitrogen outlet port followed by the monol as well as the DEM if used. The temperature was raised to 45+/−2 ° C. and mixed for 10 minutes before addition of 0.04 wt % Dabco T-9 catalyst. The mixture was then allowed to react 90 min then allowed to cool and packaged in dry glass containers blanketed with dry nitrogen.

TABLE 1
Raw Materials

| Component | Description | Supplier |
|---|---|---|
| VORANOL | propylene glycol initiated polyoxypropylene | The Dow Chemical |
| 232-036N | based triol, 1558 HEW | Company |
| VORANOL | propylene glycol initiated polyoxypropylene | The Dow Chemical |
| 220-056N | based diol, 1000 HEW | Company |
| Palatinol N | diisononylphthalate (DINP) | BASF Corporation |
| | | North America |
| Dabco T-9 | stannous octoate | Air Products and |
| | | Chemicals, Inc. |
| DEM | diethyl malonate (DEM) | Solvadis GmbH |
| Synalox 80- | 2000 molecular weight monol based on | The Dow Chemical |
| 130B | 0.8/0.2 PE/EO | Company |
| UCON 50-HB- | 3930 molecular weight monol based on 1:1 | The Dow Chemical |
| 5100 | PO/EO | Company |
| UCON 50-HB- | 1590 molecular weight monol based on 1:1 | The Dow Chemical |
| 660 | PO/EO | Company |
| UCON 50-HB- | 970 molecular weight monol based on 1:1 | The Dow Chemical |
| 260 | PO/EO | Company |
| UCON 50-HB- | 750 molecular weight monol based on 1:1 | The Dow Chemical |
| 170 | PO/EO | Company |
| UCON 50-HB- | 520 molecular weight monol based on 1:1 | The Dow Chemical |
| 100 | PO/EO | Company |
| UCON 50 HB | 270 molecular weight monol based on 1:1 | The Dow Chemical |
| 55 | PO/EO | Company |
| UCON LB 625 | 1600 molecular weight monol based on 1:0 | The Dow Chemical |
| | PO/EO | Company |
| ISONATE | 100% 4,4′ methylenebis(diphenyl | The Dow Chemical |
| 125M | diisocyante) MDI; % NCO = 33.1 | Company |
| ISONATE 50 | 1:1 w/w isomeric mixture of 4,4′-MDI and | The Dow Chemical |
| OP | 2,4′-MDI e | Company |
| PAPI 94 | MDI mixture; equivalent weight = 130, | The Dow Chemical |
| | functionality = 2.3 | Company |
| Elftex S S7100 | carbon black | Cabot Corporation |
| Pole Star R200 | clay | Imersys Performance |
| | | Materials |
| Drikalite | calcium carbonate | Imersys Performance |
| | | Materials |
| DMDEE | 2,2′-dimorpholinodiethylether | Huntsman Corporation |
| Bicat 8 | bismuth octoate | The Shepher Chemical |
| | | Company |
| Fomrez UL 28 | Dimethyltin bisneodecanoate | Momentive Performance |
| | | Materials |

TABLE 2
Reactive Plasticizers Made with PAPI 94 polyisocyanate

| | | | | | Comp | Comp | Comp | Comp | Comp |
|---|---|---|---|---|---|---|---|---|---|
| Ingredients/ | Ex. | Ex. | Ex. | Ex. | Ex. | Ex. | Ex. | Ex. | Ex. |
| Characteristics | RP 1 | RP 2 | RP 3 | RP 4 | RP 1 | RP 2 | RP 3 | RP 4 | RP 5 |
| UCON 50-HB-660 | 93.70 | 0.00 | 0.00 | 0.00 | 0.00 | 0.00 | 0.00 | 0.00 | 0.00 |
| UCON 50-HB-260 | 0.00 | 89.50 | 0.00 | 0.00 | 0.00 | 90.50 | 91.50 | 0.00 | 0.00 |
| UCON 50-HB-170 | 0.00 | 0.00 | 86.50 | 0.00 | 0.00 | 0.00 | 0.00 | 0.00 | 0.00 |
| UCON 50-HB-100 | 0.00 | 0.00 | 0.00 | 81.00 | 0.00 | 0.00 | 0.00 | 0.00 | 0.00 |
| UCON-50-HB-5100 | 0.00 | 0.00 | 0.00 | 0.00 | 97.93 | 0.00 | 0.00 | 0.00 | 0.00 |
| Synalox 80-130B | 0.00 | 0.00 | 0.00 | 0.00 | 0.00 | 0.00 | 0.00 | 93.5 | 0.00 |
| UCON LB 625 | 0.00 | 0.00 | 0.00 | 0.00 | 0.00 | 0.00 | 0.00 | 0.00 | 92 |
| PAPI 94 | 6.23 | 10.43 | 13.43 | 18.93 | 2.00 | 9.43 | 8.43 | 6.5 | 7.95 |
| DABCO T-9 Catalyst | 0.006 | 0.006 | 0.006 | 0.006 | 0.006 | 0.006 | 0.006 | 0.006 | 0.006 |
| DEM | 0.050 | 0.050 | 0.050 | 0.050 | 0.050 | 0.050 | 0.050 | 0.050 | 0.05 |
| Total | 100 | 100 | 100 | 100 | 100 | 100 | 100 | 100 | 100 |
| NCO 24 hr RT, (%) | 0.04 | 0.07 | 0.06 | 0.05 | 0.22 | 0 | 0 | 0.11 | 0.25 |
| Viscosity 24 hr RT, (cP) | 1690 | 1290 | 1140 | 1711 | 2720 | 1540 | 1600 | 2780 | 2220 |
| NCO 30 D RT, (%) | 0.03 | 0.08 | 0.06 | 0.04 | 0.01 | 0 | 0 | 0.02 | 0.07 |
| Viscosity 30 D RT, (cP) | 3560 | 1660 | 2040 | 3120 | 2880 | 1540 | 1600 | 4320 | 3950 |
| Mn | NA | 3568 | 2715 | NA | NA | NA | NA | 5225 | 4459 |
| Mw | NA | 4404 | 3366 | NA | NA | NA | NA | 6434 | 5530 |

TABLE 3
Reactive plasticizers made with ISONATE 50 OP polyisocyanate

| Ingredients/ | Ex. | Ex. | Ex. | Ex. |
|---|---|---|---|---|
| Characteristics | RP 5 | RP 6 | RP 7 | RP 8 |
| UCON 50-HB-660 | 94.00 | 0.00 | 0.00 | 0.00 |
| UCON 50-HB-260 | 0.00 | 90.00 | 0.00 | 0.00 |
| UCON 50-HB-170 | 0.00 | 0.00 | 87.00 | 0.00 |
| UCON 50-HB-100 | 0.00 | 0.00 | 0.00 | 82.00 |
| Isonate 50 OP | 6.00 | 10.00 | 13.00 | 18.00 |
| DABCO T-9 Catalyst | 0.006 | 0.006 | 0.006 | 0.006 |
| DEM | 0.050 | 0.050 | 0.050 | 0.050 |
| Total | 100.07 | 100.07 | 100.07 | 100.07 |
| NCO 24 hr RT, (%) | 0.29 | 0.08 | 0.18 | 0.08 |
| Viscosity 24 hr RT, (cP) | 1680 | 1300 | 1290 | 1560 |
| Mn | 4876 | 3059 | 2281 | 1709 |
| Mw | 5824 | 3506 | 2630 | 1926 |

TABLE 4
Reactive plasticizers made with ISONATE 125M polyisocyanate

| Ingredients/ | Ex. | Ex. | Ex. |
|---|---|---|---|
| Characteristics | RP 9 | RP 10 | RP 11 |
| UCON 50 260 | 90 | 89.5 | 89.0 |
| ISONATE 125 | 10 | 10.5 | 11 |
| DABCO T-9 Catalyst | 0.004 | 0.004 | 0.004 |
| Total | 100 | 100 | 100 |
| NCO 24 hr RT, (%) | 0.12 | 0.20 | 0.19 |
| Viscosity 24 hr RT, (cP) | 850 | 1200 | 1426 |

TABLE 5
Screening Test Results:

| | | | | | | | | | Comp. | Comp | Comp |
|---|---|---|---|---|---|---|---|---|---|---|---|
| | | Ex. | Ex. | Ex. | Ex. | Ex. | Ex. | Ex. | Ex. | Ex. | Ex. |
| Characteristic | Ref* | RP 1 | RP 2 | RP 3 | RP 4 | RP 5 | RP 6 | RP 7 | RP 2 | RP 4 | RP 5 |
| Viscosity | 250 | 6946 | 3681 | 3968 | 1851 | 2357 | 1783 | 1850 | 3000 | 1690 | 1290 |
| (cP) | | | | | | | | | | | |
| Shear | 22000 | 1083 | 8500 | 1213 | 735 | 46380 | 42480 | 22810 | 3320 | 46380 | 42480 |
| storage | | | | | | | | | | | |
| modulus G′ | | | | | | | | | | | |
| (Pa) | | | | | | | | | | | |

Ref* = Palatinol N plasticizer mixed with 15% carbon black.

A screening test was done to screen the rheological and viscosity performance of the reactive plasticizers. In the test 15% by weight of the carbon black is mixed with a plasticizer and the viscosity and shear modulus is determined. A desirable plasticizer will typically have a high shear stress and low viscosity when mixed with the carbon black as shown by the known unreactive plasticizer used in the Reference. Desirable plasticizers generally contribute to one part moisture cured polyurethane adhesives having desirable rheological performance such as minimal sag and stringing when applying the adhesive to install windshields.

From the screening test, it is evident when examining Examples RP 1-4 that the viscosity of the reactive plasticizer tends to increase as the molecular weight of the monol used to make the plasticizer increases or decreases from about 1000 molecular weight. It is also evident that the reactive plasticizers using Papi 94 (Examples RP 1-4) a polymeric MDI do not realize as desirable shear modulus as ISONATE 50 OP (Examples RP 5-7) a 1:1 w/w isomeric mixture of 4,4′-MDI and 2,4′-MDI. Even more surprising, but not shown in Table 5 is that ISONATE 125 M isocyanate when made into a reactive plasticizer (Examples RP 14-16), even though the ISONATE 125 M isocyanate is a solid, it realizes low viscosities and high shear modulus akin to Example RP 7.

Table 5 also shows that desirable rheological properties may be made where the plasticizer is not isocyanate terminated (i.e., no isocyanate present) as in Comp. Ex. 1, but when these are combined with an isocyanate terminated prepolymer necessary to make an adhesive, the prepolymer exhibits too high a viscosity or the prepolymer is unstable (viscosity rises quickly with time). Likewise, the rheological properties of a reactive plasticizer using a monol having the appropriate molecular weight, but not a sufficient EO/PO ratio results in undesirable adhesives as further described below.

### Prepolymer Preparation

3000 gram prepolymer batches were prepared individually in a 4000 ml Pyrex glass reactor fitted with 4-port ground glass lid to accommodate an air driven stirring blade, digital thermometer, dry nitrogen gas inlet and nitrogen outlet. The reaction temperature was controlled using a heating jacket connected to an automatic electronic control module. The prepolymers shown in Table 6 were made by two different methods as follows.

### EXAMPLES PP 1-3

Prepolymer Examples PP 1-3 were made by first introducing ISONATE 125 M isocyanate to a covered reactor through the nitrogen outlet port followed by VORANOL 220-056 N and VORANOL 232-036 N polyols in the amounts shown in Table 6. The temperature was raised to 45+/−2 ° C. and mixed for 10 minutes before addition of 0.04 wt % Dabco T-9 catalyst. The mixture was then allowed to react 90 min then the reactive plasticizer and DEM were added, mixed for 15 min, allowed to cool and packaged in dry glass containers blanketed with dry nitrogen.

### COMPARATIVE EXAMPLES PP 1-3

Comparative Example PP 2 and 3 were made in the same way as Examples PP 1-3 with the ingredients used as shown in Table 6. Comparative Example PP 1 was made as follows. The reactive plasticizer (Ex. RP 2) was first introduced into the covered reactor through the nitrogen outlet port followed by Isonate 125 M isocyanate, VORANOL 220-056 N and VORANOL 232-036 N polyols. The temperature was raised to 45+/−2 ° C. and mixed for 10 minutes before addition of 0.04 wt % Dabco T-9 catalyst. The mixture was then allowed to react 90 min and allowed to cool and packaged in dry glass containers blanketed with dry nitrogen. The reactive plasticizer reacts during the formation of the prepolymer in this method and the resultant adhesive properties are detrimentally affected as shown below. In addition, examples of reactive prepolymers falling within the scope of the invention, when added during the prepolymer formation resulted in prepolymers having rheological properties that were useable, but the adhesive properties were also detrimentally affected.

TABLE 6
Prepolymers having Reactive Plasticizers

| | Ex. | Ex. | Ex. | Comp. | Comp. | Comp. |
|---|---|---|---|---|---|---|
| | PP 1 | PP 2 | PP 3 | Ex. PP 1 | Ex. PP 2 | Ex. PP 3 |
| Ingredients/ | | | | | | |
| Characteristics | | | | | | |
| VORANOL | 31 | 31 | 31 | 31 | 31 | 31 |
| 232-036N | | | | | | |
| VORANOL | 21 | 21 | 21 | 21 | 21 | 21 |
| 220-056N | | | | | | |
| ISONATE 125 | 10.7 | 10.75 | 10.75 | 10.75 | 10.75 | 10.75 |
| DEM | 0.75 | | | | | |
| Ex. RP 6 | 36.55 | | | | | |
| Ex. RP 9 | | 37.25 | | | | |
| Ex. RP 2 | | | 37.25 | | | |
| Comp. Ex. RP 3 | | | | 37.25 | | |
| Comp. Ex. RP 4 | | | | | 37.25 | |
| Comp. Ex. RP 5 | | | | | | 37.25 |
| 24 Hr NCO (%) | 1.83 | 1.69 | 1.53 | 0.98 | 1.66 | 1.69 |
| 24 Hr Viscosity | 22400 | 19200 | 42000 | >100000 | 46000 | 38000 |
| (cP) | | | | | | |
| Color / Clarity | Clear | Clear | Clear | Clear | Clear | Clear |

### Adhesive Preparation

Adhesives were prepared in 8 liter Double Planetary Mixer. To the clean and dry mixer, all prepolymer was added, the mixer lid was closed and vacuum pulled for 10 min. The mixer lid was opened and dry nitrogen gas is used to blanket the prepolymer. Fillers, dried at 200°C. for 16 to 20 hrs, are added to the mixer, the lid is closed and mixer started for 5 min without vacuum and then 10 min under vacuum. The mixer is opened, the bowl blanketed with dry nitrogen while it and the blades are scraped down. Catalysts and all other additives are added and mixing continued 10 min under vacuum before the sample is packaged into 300 ml aluminum cartridges and stored in aluminum pouches sealed under dry nitrogen.

From Table 7, the adhesive Examples 1 through 6 show that an adhesive having desirable rheological properties may be formed as shown by the low press flow viscosity and high shear modulus G′ and yield stress as well as good mechanical properties such as high tensile strength, high elongation %, tear strength and good Young' modulus. Examples 1 and 5 and Comparative Example 2 appear to demonstrate that an adhesive prepared with a significant amount of reactive plasticizer that is not derived from pure 4,4′ methylene-bis(diphenyl diisocyante) as in ISONATE 125 M isocyanate, tends to cause the cure of the adhesive to be sensitive to the amount of a blocking agent (e.g., DEM) in the adhesive. That is, Example 1, even though it has a significant amount of DEM, still cured quickly and gave excellent mechanical properties whereas Comparative Example 2 did not, which appears to be due at least in part due presence of Ex. RP 7, which was made from ISONATE 50 OP isocyanate (1:1 w/w isomeric mixture of 4,4′-MDI and 2,4′-MDI). Likewise, Example 5, which is essentially the same as Comp. Ex. 2, but without any DEM cured and resulted in good mechanical properties. Thus, not only is it surprising that the reactive plasticizers made from 4,4′ methylenebis(diphenyl diisocyanate) realize liquids when reacted with the monols, but they also appear to result in adhesive compositions less sensitive to formulation changes such as inclusion of a blocking agent such as DEM.

Comparative Example 4 shows that when the reactive plasticizer is made from a monol having insufficient ethylene oxide units in the backbone, the cured adhesive properties substantially suffer. Likewise, Comparative 5 shows that when the monol used to make the reactive plasticizer has too high a molecular weight and or too low of an EO/PO ratio the adhesive failed to cure even in the total absence of a blocking agent such as DEM.

Examples 2 through 5 demonstrate that the adhesive compositions even in the presence of significant amounts of reactive plasticizer made using ISONATE isocyanate (1:1 w/w isomeric mixture of 4,4′-MDI and 2,4′-MDI), in the absence of a blocking agent, the adhesive may have varying formulations (particularly) filler and still realize good rheological and mechanical properties.

Comparative 1 shows that if the reactive prepolymer is not isocyanate terminated and/or is present during the reaction to form the prepolymer, the adhesive fails to have sufficient mechanical properties.

TABLE 7
Adhesives

| Adhesive | | | | | | | Comp | Comp. | Comp | Comp |
|---|---|---|---|---|---|---|---|---|---|---|
| Ingredient | Ex 1 | Ex 2 | Ex 3 | Ex 4 | Ex 5 | Ex. 6 | Ex. 1 | Ex 2 | Ex. 4 | Ex. 3 |
| Ex. PP 1 | 62.3 | | | | | | | | | |
| Ex. PP 2 | | 71.8 | 56 | 64 | 52.9 | | | 53.5 | | |
| Ex. PP 3 | | | | | | 60.5 | | | | |
| (PAPI/U260) | | | | | | | | | | |
| Comp. Ex. PP 1 | | | | | | | 52.5 | | | |
| Comp. Ex. PP 2 | | | | | | | | | 53.5 | |
| (PAPI/Synalox) | | | | | | | | | | |
| Comp. Ex. PP 3 | | | | | | | | | | 53.5 |
| (PAPI/LB625) | | | | | | | | | | |
| Elftex S7100 | 18.5 | 27 | 10 | 25 | 19 | 18.5 | 18.5 | 18.5 | 18.5 | 18.5 |
| Polestar 200 | 18.5 | 0 | 24.4 | 0 | 19 | 18.5 | 20 | 18.5 | 18.5 | 18.5 |
| Ex. RP 7 | | | 8.5 | 10 | 8 | 0 | 8 | 8.5 | 8.5 | 8.5 |
| Bismuth | 0.35 | 0 | 0 | 0 | 0 | 0 | 0 | 0.25 | 0.25 | 0.25 |
| Octoate 8.2 | | | | | | | | | | |
| Fomrez UL-28 | 0 | 0.035 | 0.035 | 0.025 | 0.035 | 0.025 | 0.025 | 0 | 0 | 0 |
| JEEFCAT | 0.35 | 0.35 | 0.25 | 0.25 | 0.25 | 0.25 | 0.25 | 0.25 | 0.25 | 0.25 |
| DMDEE | | | | | | | | | | |
| DEM | 1 | 0 | 0 | 0 | 0 | 0 | 0 | 0.5 | 0.5 | 0 |
| Total Wt % | 100 | 100 | 100 | 100 | 100 | 100 | 100 | 100 | 100 | 100 |
| Adhesive | | | | | | | | | | |
| Properties | | | | | | | | | | |
| Viscosity | 53 | 118 | 44 | 30 | 36 | 48.5 | 51.5 | 38 | 44 | 44 |
| (sec/20 g, 23 C.) | | | | | | | | | | |
| G′ (Pa × | 1.3 | 1.4 | NA | 1.11 | 1.19 | 1.27 | 0.92 | 0.81 | 0.67 | 0.9 |
| 1×E+06) | | | | | | | | | | |
| Yield Stress | 8040 | 7848 | NA | 5479 | 6053 | 5170 | 4370 | 4426 | 3400 | 4542 |
| (Pa) | | | | | | | | | | |
| Tensile | 10.71 | 10.61 | 6.79 | 6.61 | 7.55 | 6.86 | 3.11 | Tacky | 3.45 | Tacky |
| Strength (MPa) | | | | | | | | | | |
| Elongation (%) | 700 | 800 | 770 | 721 | 685 | 676 | 578 | Tacky | 370 | Tacky |
| Tear (N/mm) | 30 | 35 | 23 | 20 | 27 | 18 | 12 | Tacky | 2.2 | Tacky |
| Young's | 2.7 | 2.8 | 2.1 | 1.3 | 2.6 | 2.3 | 1.2 | Tacky | 1.3 | Tacky |
| Modulus | | | | | | | | | | |

What is claimed is:

1. A reactive plasticizer comprising the reaction product of a first reactant of an isocyanate having two isocyanate groups and a second reactant of a linear polyether monol having one alcohol group, said monol having a weight average molecular weight of about 500 to about 2000 grams/mole, wherein the amount of isocyanate and the linear polyether monol are such that the isocyanate groups are in molar excess of the amount of alcohol groups and the reaction product has an isocyanate content of 0.01% to 1% by weight of the reaction product;
wherein the isocyanate and the linear polyether monol are the only reactants.

2. The reactive plasticizer of claim 1, wherein the isocyanate is ethylene diisocyanate; isophorone diisocyanate; bis(4-isocyanate cyclohexyl) methane; trimethyl hexamethylene diisocyanate; 1,4-tetramethylene diisocyanate; 1,6-hexamethylene diisocyanate; 1,12-dodecane diisocyanate; cyclobutane-1,3-diisocyanate; cyclohexanel,3-diisocyanate; 1,4-diisocyanate; 1-isocyanato3,3,5-trimethyl5-isocyanato methyl cyclohexane; 2,4-hexahydrotolylene diisocyanate; 2,6-hexahydrotolylene diisocyanate; hexahydro1,3-phenylene diisocyanate; hexahydrol,4-phenylene diisocyanate; perhydro2,5′-diphenyl methane diisocyanate; 4,4′-diphenyl methane diisocyanate; 2,4′-diphenyl methane diisocyanate; 2,2′-diphenyl methane diisocyanate; 1,3-phenylene diisocyanate; 1,4-phenylene diisocyanate; 2,4′-tolylene diisocyanate; 2,6-tolylene diisocyanate and diphenylmethane2,4′-diisocyanate; diphenylmethane 4,4′-diisocyanate, naphthylene1,5-diisocyanate; tetramethylxylene diisocyanate or mixtures thereof.

3. The reactive plasticizer of claim 2, wherein the isocyanate is 4,4′-diphenyl methane diisocyanate; 2,4′-diphenyl methane diisocyanate; 2,2′-diphenyl methane diisocyanate; or mixture thereof.

4. The reactive plasticizer of claim 3, wherein the isocyanate is 4,4′-diphenyl methane diisocyanate.

5. The reactive plasticizer of claim 1, wherein the weight average molecular weight of the reaction product is about 750 to about 2000 g/mole.

6. The reactive plasticizer of claim 1, wherein the isocyanate content is 0.4% to 1% by weight of the reaction product.

7. The reactive plasticizer of claim 1, wherein the linear polyether monol is comprised of alkylene oxide units with one end of the monol being an alcohol group and the other end of the monol being a group unreactive with an isocyanate or alcohol group.

8. The reactive plasticizer of claim 1, wherein the isocyanate groups are reacted only with the alcohol group supplied from the linear polyether monol.

9. The reactive plasticizer of claim 1, wherein the isocyanate has an average functionality of 1.8 to 2.2.

10. The reactive plasticizer of claim 9, wherein a molar ratio of isocyanate groups to alcohol groups is 1.001 to 1.05.

11. The reactive plasticizer of claim 9, wherein the backbone of the linear polyether monol includes alkylene oxide units.

12. The reactive plasticizer of claim 11, wherein the alkylene oxide units include propylene oxide and ethyene oxide.

13. The reactive plasticizer of claim 1, wherein the reaction product has an isocyanate content of less than 1% by weight of the reaction product.

14. The reactive plasticizer of claim 9, wherein the isocyanate consists of one or more diisocyanates.

15. A reactive plasticizer comprising the reaction product of an isocyanate having two isocyanate groups and a single linear polyether monol having one alcohol group, said monol having a weight average molecular weight of about 500 to about 2000 grams/mole, wherein the amount of isocyanate and the single linear polyether monol are such that the isocyanate groups are in molar excess of the amount of alcohol groups and the reaction product has an isocyanate content of 0.01% to 1% by weight of the reaction product;
wherein the isocyanate has a functionality of 1.9 to 2.1, and the single linear polyether monol has one end that is terminated with an ether or an ester.

16. The reactive plasticizer of claim 15, wherein the linear polyether monol has one end that is terminated with an ether.

17. The reactive plasticizer of claim 15, wherein the isocyanate consists of one or more diisocyanates.

18. The reactive plasticizer of claim 15, wherein the isocyanate has an average functionality of 1.96 to 2.04.

19. The reactive plasticizer of claim 15, wherein the linear polyether monol has a backbone formed from both ethylene oxide and propylene oxide.

20. The reactive plasticizer of claim 15, wherein the reaction product has an isocyanate content of less than 1% by weight of the reaction product.
